(19) United States
(12) Patent Application Publication
(10) Pub. No.: US 2024/0316850 A1
(43) Pub. Date: Sep. 26, 2024

(54) INJECTION MOLDING SYSTEM AND CONTROL METHOD FOR INJECTION MOLDING SYSTEM

(71) Applicant: SEIKO EPSON CORPORATION, Tokyo (JP)

(72) Inventor: Seijun HORIE, Matsumoto-Shi (JP)

(21) Appl. No.: 18/610,309

(22) Filed: Mar. 20, 2024

(30) Foreign Application Priority Data
Mar. 22, 2023 (JP) 2023-045056

(51) Int. Cl. B29C 45/76

(52) U.S. Cl. CPC B29C 45/7686; B29C 2945/76795

(57) ABSTRACT

An injection molding system includes an injection molding section that molds a workpiece by injection molding, a robot that transports the workpiece, an inspection section that inspects the workpiece transported by the robot, and a control section that controls the injection molding section, the robot and the inspection section, wherein the control section has, as control modes of the robot, a first control mode, which is performed when the inspection section is not inspecting the workpiece, and a second control mode, which is performed when the inspection section is inspecting the workpiece, and in which the robot is operated to suppress vibration of the inspection section more than is in the first control mode.

### CROSS-REFERENCE TO RELATED APPLICATIONS

The present application is based on, and claims priority from JP Application Serial Number 2023-045056, filed Mar. 22, 2023, the disclosure of which is hereby incorporated by reference herein in its entirety.

### BACKGROUND OF THE INVENTION

### 1. Technical Field

The present disclosure relates to an injection molding system and a control method for the injection molding system.

### 2. Related Art

In an injection molding machine disclosed in JP-A-10-95028, the platform has a mounting section on which are mounted a product take-out robot and a peripheral device. The product take-out robot takes out product, which was molded by the injection molding machine, from the injection molding machine. The platform is rigidly fixed to a main body of the injection molding machine. A product inspection device is disclosed as the peripheral device. In JP-A-10-95028, when the injection molding machine is moved to a different location, the product take-out robot, the peripheral device, and the injection molding machine are transported as one integrated unit. Therefore, when the injection molding machine is moved, there is no need to separate the product take-out robot and peripheral device from the injection molding machine, thereby reducing the amount of work required.

A known method for inspecting the quality of products molded by injection molding machine is to measure the weight of the product and to compare the measured value with a reference value. In recent years, quality requirements from users for products molded by injection molding machine have been increasing, and it is expected that the user will require, for example, a difference between a reference value and the weight of a light-weight product that weighs less than 1 g. In such an injection molding machine, the product inspection device may be mounted in the mounting section where the product take-out robot is mounted.

If the product take-out robot operates while the product is being inspected in the product inspection device, the motion of the product take-out robot may cause the product inspection device to vibrate. If the product inspection device vibrates, stable measurement of the product by the product inspection device cannot be performed. Therefore, in cases where a product inspection device is affected by the vibration of the product take-out robot, there is a need for technology for suppressing the vibration of the product inspection device during product inspection.

### SUMMARY OF THE INVENTION

According to a first aspect of the present disclosure, an injection molding system is provided. This injection molding system includes an injection molding section that molds a workpiece by injection molding; a robot that transports the workpiece; an inspection section that inspects the workpiece transported by the robot; and a control section that controls the injection molding section, the robot, and the inspection section; wherein the control section has, as control modes of the robot, a first control mode that is performed when the workpiece is not being inspected by the inspection section and a second control mode that is performed when the workpiece is being inspected by the inspection section, and that causes the robot to operate so that vibration of the inspection section is suppressed more than in the first control mode.

According to a second aspect of the present disclosure, a control method for an injection molding system is provided. This control method for the injection molding system includes molding a workpiece by an injection molding section, transporting the workpiece by a robot, and by a control section, which controls the injection molding section, the robot, and an inspection section that inspects the workpiece transported by the robot, performing a first control mode as a control mode of the robot, when the workpiece is not being inspected by the inspection section; and performing a second control mode that causes the robot to operate to suppress the vibration of the inspection section more than is in the first control mode, as the control mode of the robot, when the workpiece is being inspected by the inspection section.

### BRIEF DESCRIPTION OF DRAWINGS

FIG. 1 is a perspective view of an injection molding system in this embodiment.

FIG. 2 is a block diagram showing a control section.

FIG. 3 is a block diagram showing components of a control section and the relationship between these components and a servo motor and a position sensor provided by a robot.

FIG. 4 is a graph showing an example of a specific operation that is specified for a certain servo motor of the robot.

FIG. 5 is as a result of a fast Fourier transform on the waveform of a speed of the specific operation.

FIG. 6 is a process chart showing an example of an inspection method by an inspection section.

FIG. 7 is a process chart showing an example of an inspection method by the inspection section in a second embodiment.

FIG. 8 is a process chart showing an example of a inspection method by the inspection section in a third embodiment.

FIG. 9 is a front view showing a schematic configuration of an injection molding system of a sixth embodiment.

FIG. 10 is a plan view showing the schematic configuration of the injection molding system of the sixth embodiment.

### DETAILED DESCRIPTION OF THE INVENTION

### A. First Embodiment

### A1. Configuration of First Embodiment

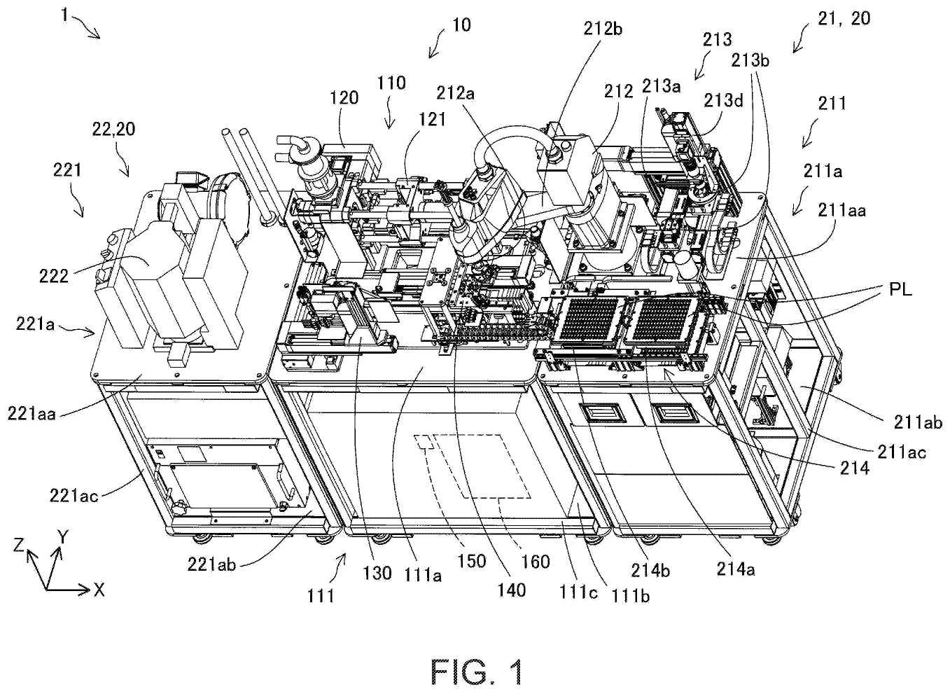

FIG. 1 is a perspective view of an injection molding system 1 in this embodiment. FIG. 1 shows mutually orthogonal directions X, Y and Z. In this embodiment, the X direction is a direction in which components of the injection molding system 1 are aligned, and from a-X direction to a +X direction, a second unit 22 (to be described later), an injection molding section 10, and a first unit 21 are aligned in this order. The Z direction is the vertical direction, and a +Z direction is an upward direction in the vertical direction. The X direction is a horizontal direction. The Y direction is a direction perpendicular to the X and Z directions.

The injection molding system 1 molds a plurality of workpieces WK by injection molding, inspects quality of each of the molded plurality of workpieces WK, and records the inspection results. In this embodiment, the injection molding system 1 can automatically mold a workpiece WK by injection molding, inspect the workpiece WK, and record the inspection results. As shown in FIG. 1, the injection molding system 1 is equipped with an injection molding section 10 and an optional unit 20.

The injection molding section 10 molds the workpiece WK by injection molding. The injection molding section 10 has a first housing 110, an injection molding machine 120, a take-out device 130, a transport device 140, a storage section 150, and a control section 160. The injection molding section 10 can also be referred to as an injection molding unit.

The injection molding machine 120, the take-out device 130, the transport device 140, and the control section 160 are located in the first housing 110. The first housing 110 is detachably connected to the optional unit 20. The first housing 110 has a first base section 111, a first upper frame 112, and a first cover 113. Note that the first upper frame 112 and the first cover 113 are not shown.

The first base section 111 is constituted by a first base 111a, a second base 111b, and a first base frame 111c. On the first base 111a, the injection molding machine 120, the take-out device 130, and the transport device 140 are located. The first base 111a is located vertically above the second base 111b. The first base 111a is a plate-shaped member. The storage section 150 and the control section 160 are located on the second base 111b. The second base 111b is a plate-shaped member. The first base frame 111c fixes the first base 111a and the second base 111b. The first base frame 111c is a cube-shaped frame connected to the first base 111a and the second base 111b. The first upper frame 112 surrounds the injection molding machine 120, the take-out device 130, and the transport device 140. The first upper frame 112 is located above the first base 111a. The first cover 113 is attached to the first base section 111 and the first upper frame 112, and is provided at least on the −Y and +Y direction-side end portions of the first base section 111 and of the first upper frame 112.

The injection molding machine 120 is a device that molds a workpiece WK by injecting molten material. The injection molding machine 120 is located to the +Y direction side of the first base 111a with respect to the take-out device 130 and the transport device 140. In this embodiment, the injection molding machine 120 has a structure in which an injection unit, through which the material flows, and a molding die clamping mechanism 121, which opens and closes the molding die, are arranged in the horizontal direction. The take-out device 130 is a device that takes out the workpiece WK molded by the injection molding machine 120 from the injection molding machine 120. The take-out device 130 transports the workpiece WK, which was removed from the injection molding machine 120, to the transport device 140 and places it on the transport device 140. The take-out device 130 is located on the first base 111a, on the −Y direction side with respect to the injection molding machine 120 and on the −X direction side with respect to the transport device 140.

The transport device 140 transports the workpiece WK transported by the take-out device 130 from the end portion of the −X direction side of the transport device 140 to the end portion of the +X direction side of the transport device 140. The transport device 140 cuts gate sections and liners that remain on the workpiece WK in the process of transporting the workpiece WK. The storage section 150 records an inspection result of the workpiece WK.

Before describing the control section 160, the optional unit 20 will be described. The optional unit 20 stores and dries material of the workpiece WK m, and inspects the workpiece WK. The optional unit 20 has a first unit 21 and a second unit 22.

The first unit 21 inspects the workpiece WK. The first unit 21 is located on the +X direction side with respect to the injection molding section 10. In this embodiment, the first unit 21 is configured to be detachable from the injection molding section 10. The first unit 21 has a second housing 211, a robot 212, an inspection section 213, and a stacking mechanism 214.

The second housing 211 houses the robot 212, the inspection section 213, and the stacking mechanism 214. Specifically, in the second housing 211, the robot 212 and the inspection section 213 are located on the first base 211aa of the second base section 211a (to be described later). The second housing 211 also houses the stacking mechanism 214 so that it protrudes upward from the inside of the second base section 211a. The second housing 211 has the second base section 211a, a second upper frame 211b, and a second cover 211c. The second upper frame 211b and the second cover 211c are not shown.

The second base section 211a is configured from the first base 211aa, a second base 211ab, and a second base frame 211ac. The robot 212 and the inspection section 213 are located on the first base 211aa. The first base 211aa is located above the second base 211ab in the vertical direction. The first base 211aa is a plate-shaped member. The second base 211ab is a plate-shaped member. The second base frame 211ac fixes the first base 211aa and the second base 211ab. The second base frame 211ac is a cube-shaped frame that connects the first base 211aa and the second base 211ab. The second upper frame 211b surrounds the robot 212 and the inspection section 213. The second upper frame 211b is located on the first base 211aa. The second cover 211c is attached to the second base section 211a and the second upper frame 211b. The second cover 211c is provided on at least the −Y, +Y, and +X direction-side end portions of the second base section 211a and the second upper frame 211b.

The robot 212 is a device that transports the workpiece WK. In this embodiment, the robot 212 is configured as a horizontal articulated robot, which is driven by multiple actuators. Note that the robot 212 does not have to be a horizontal articulated robot, for example, it can be a Cartesian coordinate robot or a vertically articulated robot with multiple axes. When employing a horizontal articulated robot, it is easy to mount the robot on the first unit 21. The robot 212 grips the workpiece WK that was transported by the transport device 140 to the +X direction end portion of the transport device 140, and moves that workpiece WK to the inspection section 213. Further, the robot 212 moves the workpiece WK that was inspected by the inspection section 213 to a pallet PL located on the stacking mechanism 214, and places the workpiece on the pallet PL. The robot 212 discharges a workpiece WK that was determined to be a defective product by the inspection section 213 to a defective product discharge area (not shown), which is provided in the second housing 211 by the robot 212. The robot 212 is located in the second housing 211 on the −X direction side of the inspection section 213 and the +Y direction side of the stacking mechanism 214.

The robot 212 has a holding section 212a, a movable section 212b, a servo motor 212c (not shown), and a servo amplifier 212d (not shown). The holding section 212a can hold and release the workpiece WK. The holding section 212a is connected to the movable section 212b. The movable section 212b can be moved relative with respect to the located position of the robot 212. The workpiece WK can be transported by the movement of the movable section 212b. The servo motor 212c drives each joint of the robot 212. A position sensor 212e (not shown) is attached to each servo motor 212c. The position sensor 212e detects a rotational position and a rotation speed of the servo motor 212c, and sends them to the control section 160. The servo amplifier 212d controls the servo motor 212c.

The inspection section 213 inspects the workpiece WK transported by the robot 212. In this embodiment, the inspection section 213 inspects a quality of the workpiece WK based on a difference between the shape of the workpiece WK and a pre-input shape of a reference workpiece WK, and determines whether the workpiece WK is good or bad. Note that the inspection section 213 may inspect the quality of the workpiece WK based on a difference between the weight of the workpiece WK and the weight of the reference workpiece WK input in advance. Further, the inspection section 213 sends a signal indicating an inspection result to the control section 160.

The inspection section 213 is mounted on the second housing 211, which is the same mounting section as the robot 212 Specifically, the inspection section 213 is provided on the +X direction side of the robot 212 in the second housing 211. The size of the injection molding system 1 can be reduced compared to a configuration in which each of the inspection section 213 and robot 212 mounts on a different mounting section. The inspection section 213 is located within a movable range of the robot 212. The size of the injection molding system 1 can be reduced compared to a configuration in which the inspection section 213 is located outside the movable range of the robot 212. By configuring the robot 212 to transport and place the workpiece WK in the inspection section 213, for example, it is not necessary for the operator to manually transport the workpiece KW molded in the injection molding section 10 to the inspection section 213. In this embodiment, vibration caused by operation of the robot 212 is transmitted to the inspection section 213. The inspection section 213 has a camera 213a, an inspection table 213b, and a vibration measurement section 213c. Note that the vibration measurement section 213c is not shown in FIG. 1.

The camera 213a is attached to a support pillar 213d on the first base 211aa, and captures an image of the workpiece WK from above the workpiece WK in the vertical direction. The support pillar 213d has a mechanism that can move in the X-axis direction. Based on the image captured by the camera 213a, the appearance of the workpiece WK is inspected. The inspection table 213b is a table on which the workpiece WK is placed. A plurality of inspection tables 213b are provided on the first base 211aa of the second base section 211a, and are aligned in the X-axis direction. Each of the inspection tables 213b has a mechanism that moves in the Y-axis direction, and moves between a first position, which is vertically below the camera 213a, and a second position, which is close to the robot 212 and the stacking mechanism 214. When the inspection table 213b is in the first position, the workpiece WK placed on the inspection table 213b is captured by the camera 213a. When the inspection table 213b is in the second position, uninspected workpieces WK are placed on the inspection table 213b by the robot 212, or inspected workpieces WK are transported to the stacking mechanism 214 by the robot 212. By this, the time required for the robot 212 to transport the workpiece is shortened. It also prevents interference between the robot 212 and the camera 213a.

The vibration measurement section 213c measures the vibration of the workpiece WK placed on the inspection section 213. The vibration measurement section 213c is located in the inspection table 213b. By providing the vibration measurement section 213c in the inspection table 213b, the vibration of the workpiece WK can be measured more accurately. The vibration measurement section 213c detects a physical quantity that represents the magnitude of vibration of the workpiece WK. The physical quantity that represents the magnitude of the vibration includes a speed of the workpiece WK, a displacement of the workpiece WK, and an acceleration of the workpiece WK. In this embodiment, the vibration measurement section 213c detects the acceleration of the workpiece WK. The vibration measurement section 213c sends a signal indicating information about the detected acceleration of the workpiece WK to the control section 160. The vibration measurement section 213c may detect the speed of the workpiece WK or the displacement of the workpiece WK.

The stacking mechanism 214 is a mechanism that stacks the pallets PL containing the inspected workpieces WK carried from the inspection section 213 by the robot 212. The stacking mechanism 214 is located at the −Y direction side of the robot 212 and the inspection section 213, in the second housing 211. The stacking mechanism 214 has a first placement section 214a and a second placement section 214b. A different pallet PL is provided in each of the first placement section 214a and the second placement section 214b.

A pallet PL on which a plurality of workpieces WK inspected by the inspection section 213 are placed is mounted on the first placement section 214a. The workpiece WK is transported by the robot 212 to the pallet PL mounted on the first placement section 214a. Once a predetermined number of workpieces WK are placed on the pallet PL, the pallet PL in the first placement section 214a is lowered toward the inside of the second base section 211a. The first placement section 214a is located within the movable range of the robot 212 in the second housing 211. The second placement section 214b slides and moves the pallet PL that is located in the second placement section 214b, above the lowered pallet PL in the first placement section 214a. The second placement section 214b stacks a plurality of pallets PL in the vertical direction and moves the vertical direction topmost pallet PL toward the first placement section 214a. Then, the second placement section 214b raises the remaining pallets PL. The second placement section 214b is located within the movable range of the robot 212 in the second housing 211.

The second unit 22 dehumidifies and dries pre-stored material and feeds it to the injection molding machine 120. The second unit 22 has a third housing 221 and a feeding device 222. The third housing 221 has a third base section 221a, a third upper frame 221b, and a third cover 221c. The third upper frame 221b and the third cover 221c are not shown. The third base section 221a is constituted by two plate-shaped bases 221aa and 221ab, which are located at the upper and lower sides in the vertical direction, and a third base frame 211ac. The third base frame 211ac fixes the two bases 221aa and 221ab. The third base frame 211ac is a cube-shaped frame connected to two bases 221aa and 221ab. The third upper frame 221b is located on the base 221aa of the third base section 221a so that it surrounds the feeding device 222. The third cover 221c is attached to the third base section 221a and the third upper frame 221b, and is provided on at least the −Y, +Y and +X direction-side end portions of the third base section 221a and the third upper frame 221b. The feeding device 222 feeds resin material that is used in the injection molding machine 120 to the injection molding machine 120.

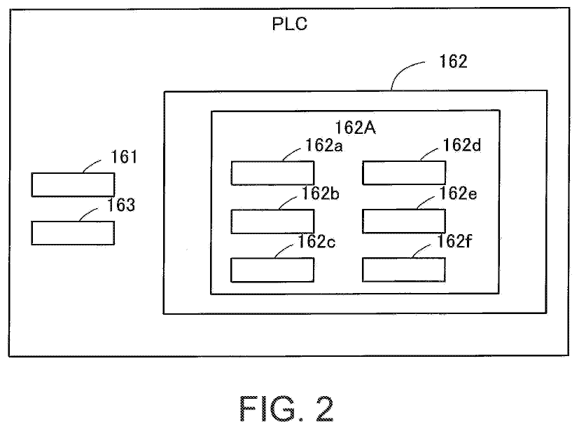

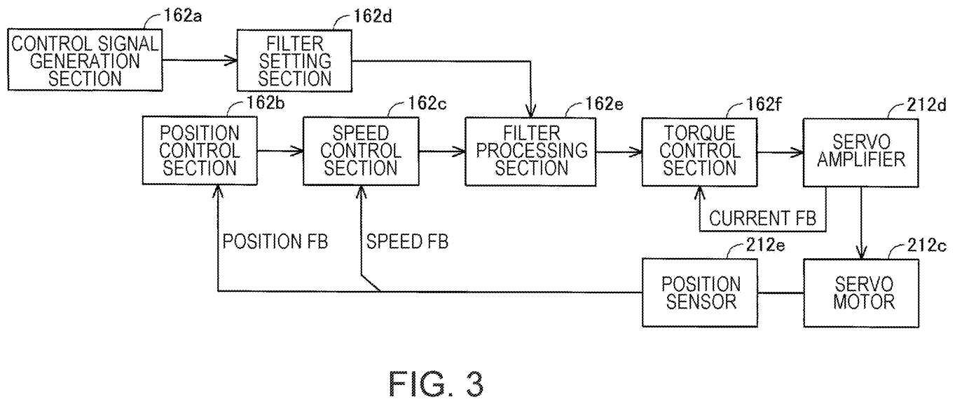

FIG. 2 is a block diagram showing the control section 160. FIG. 3 is a block diagram showing the relationship between a servo motor 212c and a position sensor 212e provided in the robot 212 and the components of the control section 160. The control section 160 is a device that controls the injection molding section 10, the first unit 21, and the second unit 22. In other words, the control section 160 controls the injection molding section 10, the robot 212, and the inspection section 213. In this embodiment, the control section 160 has a first control mode M1 and a second control mode M2 as control modes for the robot 212, and operates the robot 212 in either the first control mode M1 or the second control mode M2. Details of the first control mode M1 and the second control mode M2 will be described later.

The control section 160 is composed of a programmable logic controller (PLC). The control section 160, which is composed of a PLC, is programmed by ladder language to control the cooperative operation of the above-described devices. The control section 160 has an input section 161, an operation section 162, and an output section 163.

The input section 161 receives information indicating a state of operation of the injection molding machine 120, the robot 212, and the inspection section 213. The output section 163 sends a command sent from the operation section 162 to the injection molding machine 120, the robot 212, and the inspection section 213. The operation section 162 determines operations of the injection molding machine 120, the robot 212, and the inspection section 213 based on the information input to the input section 161. In this embodiment, the operation section 162 has a vibration reduction processing section 162A.

The vibration reduction processing section 162A generates an operation signal in which a frequency component corresponding to the natural frequency of the inspection section 213 is reduced with respect to an original operation signal to drive the robot 212, and operates the robot 212 using this operation signal. Here, the natural frequency of the inspection section 213 means the natural frequency at which the inspection section 213 resonates when the injection molding system 1 including the inspection section 213 is driven. The vibration reduction processing section 162A has a control signal generation section 162a, a position control section 162b, a speed control section 162c, a filter setting section 162d, a filter processing section 162e, and a torque control section 162f.

The control signal generation section 162a generates a position control signal representing a target position where the holding section 212a should be located, and outputs the position control signal to the position control section 162b. In this embodiment, the control signal generation section 162a receives an instruction to perform tracking control from the user, and outputs a control signal to perform the tracking control to the position control section 162b.

The position control section 162b receives the position control signal from the control signal generation section 162a. The position control section 162b receives a rotational position of each servo motor 212c from the position sensor 212e of the robot 212 as a position feedback. Further, the position control section 162b generates and outputs a speed control signal of each servo motor 212c of the robot 212 based on the received information.

The speed control section 162c receives the speed control signal from the position control section 162b. The speed control section 162c receives the rotation speed of each servo motor 212c from the position sensor 212e of the robot 212 as a speed feedback. The speed control section 162c generates and outputs the original operation signal based on the speed control signal and the rotation speed of each servo motor 212c.

The filter setting section 162d outputs a control signal indicating one or more frequencies to be removed from the original operation signal. The filter setting section 162d can also output a control signal indicating that there are no frequencies to be removed from the original operation signal.

The filter processing section 162e receives the original operation signal from the speed control section 162c. The filter processing section 162e receives a control signal indicating one or more frequencies to be removed from the filter setting section 162d. The filter processing section 162e generates and outputs a new operation signal from the original operation signal output by the speed control section 162c by processing to remove one or more frequency components according to the control signal. The filter processing section 162e performs this process using a band rejection filter.

The frequency to be removed in the filter processing section 162e is the frequency at which the inspection section 213 resonates when the injection molding system 1 including the inspection section 213 is driven. By performing these processes, it is possible to prevent a state in which the robot 212 operates at that frequency.

The torque control section 162f receives the operation signal from the filter processing section 162e. The torque control section also receives a feedback signal from the servo amplifier 212d, which represents a current amount supplied to each servo motor 212c. The torque control section 162f determines the current amount to be supplied to each servo motor 212c based on the operation signal and the current feedback signal of each servo motor 212c, and drives each servo motor 212c via the servo amplifier 212d.

### A2. Generation of New Operation Signal

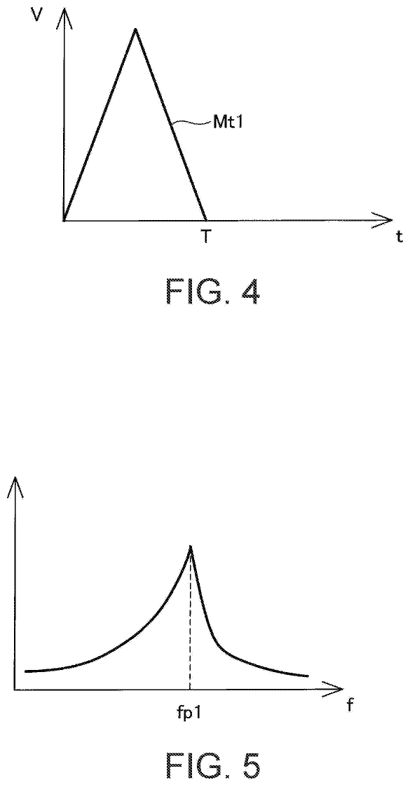

FIG. 4 is a graph showing an example of a specific operation Mt1 that is instructed to a certain servo motor 212c of the robot 212. The specific operation Mt1 is, for example, (i) an operation that the robot 212, which is holding the workpiece WK, moves toward the inspection section 213, (ii) an operation that the robot 212, which has placed the workpiece WK in the inspection section 213, moves away from the inspection section 213, (iii) an operation that the robot 212 moves toward the transport device 140 to hold the workpiece WK, and the like. The specific operation Mt1 is input to the control section 160 by the user in advance. In the graph in FIG. 4, the horizontal axis represents time t, and the vertical axis represents the movement speed V of the servo motor 212c of a certain joint. In the specific operation Mt1, the movement speed V of the servo motor 212c linearly increases from 0, then decreases linearly back to 0. The time t from the start of the specific operation Mt1 to the end of the specific operation Mt1 is T.

FIG. 5 shows a result of fast Fourier transform on the waveform of the movement speed in the specific operation Mt1. In FIG. 5, the horizontal axis represents frequency, and the vertical axis represents the effective value of power at each frequency. It can be seen that the specific operation Mt1 has the highest power at frequency fp1, and its power decreases as it separates from that frequency.

As can be seen from FIGS. 4 and 5, the power that each frequency component has differs depending on the waveform of the velocity change of the specific operation Mt1. Of each frequency component, the filter processing section 162e reduces the frequency component that resonates in the inspection section 213 when the injection molding system 1 including the inspection section 213 is driven, and performs an inverse fast Fourier transform on the waveform of the frequency of the specific operation Mt1. The filter processing section 162e generates and outputs a new operation signal based on a waveform of the speed obtained as a result.

### A3. Control Mode of Robot 212 by Control Section 160

The control section 160 performs the first control mode M1 when the workpiece WK is not being inspected by the inspection section 213. The control section 160 then performs the second control mode M2 when having the inspection section 213 inspect the workpiece WK. The second control mode M2 is a control mode that limits the motion of the robot 212 so that it vibrates the inspection section 213 less than the first control mode M1. The inspection section 213, which is the object not to be vibrated, means at least one of the camera 213a and the inspection table 213b. The first control mode M1 is a control mode that causes the robot 212 to drive faithfully to an original control signal based on the original operation signal received from the speed control section 162c. In this embodiment, the second control mode M2 is a control mode that performs one of 1) a vibration reduction control that is a control to cause the robot 212 to operate using an operation signal whose frequency component that corresponds to the natural frequency of the inspection section 213 is reduced with respect to the original operation signal for driving the robot 212, 2) an acceleration and deceleration forbidding control that forbids the robot 212 to accelerate and decelerate, and 3) a stop control that stops the operation of the robot 212. In this embodiment, the vibration reduction control is performed as the second control mode M2.

The control section 160 performs any one of the vibration reduction control, the acceleration and deceleration forbidding control, and the stop control, based on workpiece vibration information, which indicates how easily the workpiece WK itself tends to vibrate and which was obtained in advance by the user, and inspection section vibration information, which indicates how easily the inspection section 213 tends to vibrate and which was obtained in advance. The workpiece vibration information is input to the control section 160 in advance by the user based on the shape of the workpiece WK, the weight of the workpiece WK, the material of the workpiece WK, and the like. Since the control mode is selected based on the workpiece vibration information and the inspection section vibration information, the inspection section 213 can perform highly accurate inspection.

### A4. Control of Injection Molding System 1 by Control Section 160

In this embodiment, when a predetermined second control mode start condition is satisfied, the control section 160 causes the robot 212 to perform the second control mode M2. The predetermined second control mode start condition is any of (i) the magnitude of vibration of the inspection section 213 obtained by the vibration measurement section 213c, which is provided in the inspection section 213, is less than or equal to a first vibration value, which is a predetermined magnitude, (ii) a first time period, which is a predetermined time, has elapsed since the robot 212 placed the workpiece WK in the inspection section 213, and (iii) a second time period, which is a predetermined time, has elapsed since the robot 212 held the workpiece WK that is placed on the transport device 140. In this embodiment, (i) if a value obtained by the vibration measurement section 213c is smaller than the first vibration value, the control section 160 performs the second control mode M2 and causes the robot 212 to operate.

In this embodiment, the control section 160 causes the inspection section 213 to start inspection after a predetermined inspection start condition is satisfied. The predetermined inspection start condition is either of (a1) a third time period, which is a predetermined time, has elapsed since the start of the second control mode M2, or (a2) after starting the second control mode M2, the magnitude of vibration of the inspection section 213 obtained by the vibration measurement section 213c, which is provided in the inspection section 213, is less than a second vibration value, which is a predetermined magnitude. Note that the second control mode M2 does not end until the third time period, which is the predetermined time, has elapsed after the start of the second control mode M2. In this embodiment, (a2) when after starting the second control mode M2, the magnitude of vibration of the inspection section 213 obtained by the vibration measurement section 213c, which is provided in the inspection section 213, is less than a second vibration value, which is a predetermined magnitude, the control section 160 causes the inspection section 213 to start the inspection.

In this embodiment, the control section 160 ends the second control mode M2 based on a predetermined inspection end condition of the workpiece WK. The inspection end condition of the workpiece WK is either of (b1) when a fourth time period, which is a predetermined time, has elapsed since the start of the inspection of the workpiece WK or (b2) when the control section 160 has received a signal indicating end of the inspection of the workpiece WK from the inspection section 213. In this embodiment, in the case (b1) when a fourth time period, which is a predetermined time, has elapsed since the start of the inspection of the workpiece WK, the control section 160 ends the second control mode M2.

### A5. Operation of Robot 212 and Inspection by Inspection Section 213

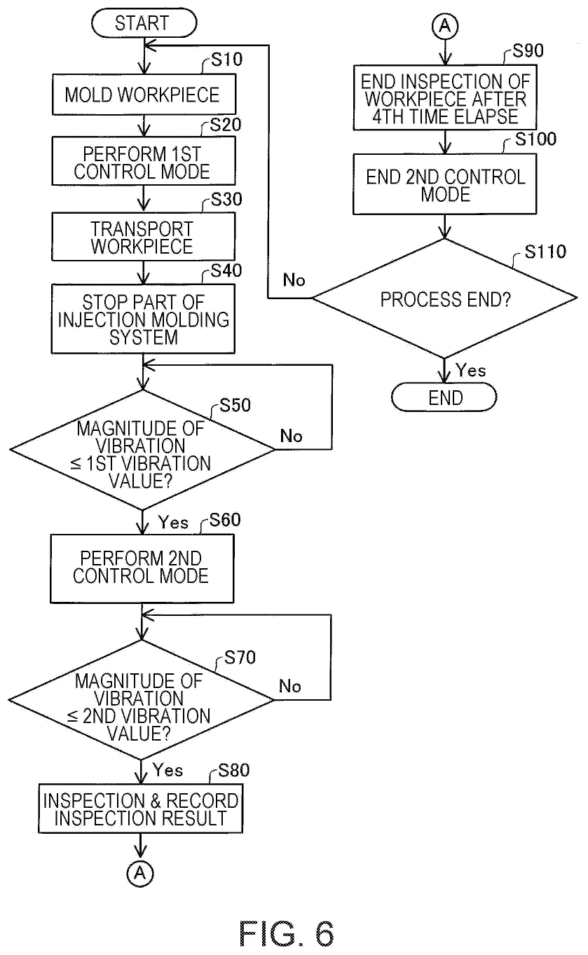

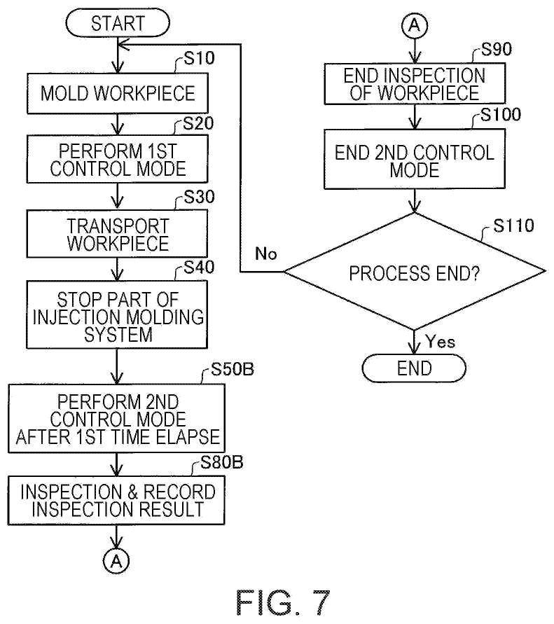

FIG. 6 is a process chart showing an example of an inspection method by the inspection section 213. The inspection by the inspection section 213 is performed under the control of the control section 160. In step S10, the workpiece WK is molded by the injection molding section 10. In step S20, the control section 160 controls the robot 212 in the first control mode M1. In step S30, the robot 212 transports the workpiece WK from the transport device 140 to the inspection section 213.

In step S40, the control section 160 stops some of the operations of the injection molding system 1. In this embodiment, the control section 160 stops the operation of the injection molding section 10. In step S50, the control section 160 determines whether the magnitude of vibration of the inspection section 213 obtained by the vibration measurement section 213c provided in the inspection section 213 is less than or equal to the first vibration value. In a case where the numerical value obtained by the vibration measurement section 213c is equal to or less than the first vibration value, the process proceeds to step S60. In a case where the numerical value obtained by the vibration measurement section 213c is larger than the first vibration value, the process proceeds to step S50 again. Note that when performing the process of step S50 again, the process of step S50 is performed again 10 seconds after the previous process of step S50.

In step S60, the control section 160 operates the robot 212 in the second control mode M2. In this embodiment, after the robot 212 places the workpiece WK in the inspection section 213, fast Fourier transform is applied to a waveform of the speed of the operation that was input to the control section 160 in advance and that is of the robot 212 departing the inspection section 213. The control section 160 generates a new operation signal based on the waveform of the speed with a reduced frequency component at which the inspection section 213 resonates. The control section 160 operates the robot 212 using this operation signal.

In step S50, the control section 160 determines whether the magnitude of vibration of the inspection section 213 obtained by the vibration measurement section 213c that is provided in the inspection section 213 is less than or equal to the second vibration value. The second vibration value is determined by the user based on the shape and weight of the workpiece WK and by the ease of vibration of the inspection section 213 in the state the workpiece WK is placed, and represents the magnitude of vibration at which the inspection section 213 can inspect the workpiece WK in a stable condition. The second vibration value is smaller than the first vibration value. If the magnitude of the vibration of the inspection section 213 obtained by the vibration measurement section 213c is equal to or less than the second vibration value, the process proceeds to step S80. If the magnitude of the vibration of the inspection section 213 obtained by the vibration measurement section 213c is larger than the second vibration value, the process proceeds to step S70 again. Note that when performing the process of step S70 again, the process of step S70 is performed again 10 seconds after the previous process of step S70.

In step S80, the workpiece WK is inspected by the inspection section 213, and a signal indicating the inspection result is sent from the inspection section 213 to the storage section 150. By this, the inspection result is stored in the storage section 150. The signal indicating the inspection result may be sent to a memory (not shown) of the control section 160, and the memory may store the inspection result.

In step S90, the control section 160 ends the inspection of the workpiece WK after the elapsed time, the fourth time period, from the time of the start of the inspection of the workpiece WK. In this embodiment, the fourth time period is 1 second. In step S100, the control section 160 ends the second control mode M2 one second after the fourth time period has elapsed. Note that the control section 160 may end the second control mode M2 at the time other than one second after the fourth time period has elapsed.

In step S110, the control section 160 determines whether to end the process or not. In this embodiment, when a predetermined number of workpieces WK have been inspected by the inspection section 213, the control section 160 determines to end the process, and the process ends. When the predetermined number of workpieces WK have not been inspected, the process proceeds to step S10 again. When the process proceeds to step S10 again, the control section 160 performs the first control mode M1 to move the robot 212 to the transport device 140. Note that information on the number of workpieces WK inspected is included in the signal indicating the inspection results, which is sent from the inspection section 213 to the control section 160.

According to the injection molding system 1 in this embodiment, the robot 212 is operated in the second control mode M2 when the workpiece WK is being inspected by the inspection section 213. Therefore, the vibration of the inspection section 213 caused by the vibration generated by the operation of the robot 212 can be suppressed compared to a control in which the workpiece WK is inspected by the inspection section 213 when the robot 212 is being operated in the first control mode M1. By this, the workpiece WK can be inspected stably when the workpiece WK is inspected.

The control section 160 performs control to operate the robot 212 using the operation signal in which the frequency component corresponding to the natural frequency including the inspection section 213 is reduced with respect to the original operation signal for driving the robot 212. Therefore, the productivity can be maintained compared to a control in which the robot 212 is stopped by the control section 160. Then, the inspection section 213 can perform a highly accurate inspection.

Since the robot 212 and the inspection section 213 are both mounted on the second housing 211, which is the same mounting section, the vibration of the robot 212 is more easily transmitted to the inspection section 213 compared to a configuration where the robot 212 and the inspection section 213 are not mounted on the same mounting section of the injection molding system 1. Since the inspection section 213 is located within the movable range of the robot 212, the vibration of the robot 212 is more easily transmitted to the inspection section 213 than is in a configuration in which the inspection section 213 is located outside the movable range of the robot 212. Therefore, it is highly possible that the inspection section 213 will vibrate in response to the vibration of the robot 212. In this embodiment, even if the robot 212 and the inspection section 213 are mounted on the same mounting section, it is possible to suppress the vibration of the inspection section 213 compared to a control in which the control section 160 does not perform the second control mode M2.

In the injection molding system 1, the molding of the workpiece WK by the injection molding section 10, the movement of the robot 212 placing the workpiece WK in the inspection section 213, and the operation of the robot 212 holding the workpiece WK may cause vibrations in the inspection section 213. In this embodiment, the control section 160 performs the second control mode M2 when the value obtained by the vibration measurement section 213c is equal to or below the first vibration value. Therefore, the control section 160 can perform the second control mode M2 in the state where the vibration of the inspection section 213 is reduced, compared to a state in which the control section 160 performs the second control mode M2 when the numerical value obtained by the vibration measurement section 213c is larger than the first vibration value. By this, the inspection section 213 can inspect the workpiece WK with a high degree of accuracy in the performance of the second control mode M2.

Further, in this embodiment, the inspection of the workpiece WK by the inspection section 213 is performed after the control section 160 determines whether the magnitude of the vibration of the inspection section 213 obtained by the vibration measurement section 213c, which is provided in the inspection section 213, is equal to or less than the second vibration value. Therefore, it is possible to perform a highly accurate inspection compared to the control in which the inspection is performed in the state in which the vibration value is larger than the second vibration value.

### B. Second Embodiment

The second embodiment differs from the first embodiment in the process in step S50 of FIG. 6, the point that the control section 160 executes an acceleration and deceleration forbidding control as the second control mode M2, and in the conditions for starting inspection. The other configuration is similar to that of the first embodiment, so the same symbols are used and a detailed description is omitted.

FIG. 7 is a process chart showing an example of an inspection method by the inspection section 213 in the second embodiment. In the second embodiment, in step S50B in FIG. 7, the control section 160 performs the second control mode M2 after the first time period, which is a predetermined time, has elapsed after the robot 212 placed the workpiece WK in the inspection section 213. In the second embodiment, the first time period is 5 seconds. In the second embodiment, the control section 160 causes the robot 212 to perform acceleration and deceleration forbidding control. In the second embodiment, the control section 160 forbids the robot 212 from accelerating and decelerating, and causes the robot 212 to perform uniform linear motion. Thereafter, the process proceeds to step S80B.

In step S80B, the inspection section 213 inspects the workpiece WK after the third time period, which is a predetermined time after the start of the second control mode M2, has elapsed and while the robot 212 is operating in the second control mode M2. The inspection result is stored in the storage section 150. In this embodiment, the third time period is 1 second. Thereafter, the process proceeds to step S90.

In the second embodiment, the same effects as in the first embodiment occur. In other words, by operating the robot 212 in the second control mode M2, the vibration of inspection section 213 caused by the vibration generated by the operation of the robot 212 can be suppressed, compared to the control in which the robot 212 is operated in the first control mode M1. By this, the workpiece WK can be inspected stably when the workpiece WK is inspected.

Since the control section 160 forbids the robot 212 from accelerating and decelerating, vibration can be suppressed in the operation of the robot 212. By this, since the transmission of the vibration of the robot 212 to the inspection section 213 is suppressed, the accuracy of the inspection by the inspection section 213 is improved.

Further, the control section 160 performs the second control mode M2 after the elapse of the first time period, which is the predetermined elapsed time from the time when the operation of the injection molding section 10 is stopped by the control section 160 and the robot 212 placed the workpiece WK in the inspection section 213. By this, the second control mode M2 is performed with a higher likelihood that the vibration of the inspection section 213 is small compared to a control in which the control section 160 performs the second control mode M2 before the first time period elapses.

In the second embodiment, the inspection section 213 inspects the workpiece WK after the elapse of the third time period after the start of the second control mode M2. Therefore, the user can control the timing of the start of the inspection.

### C. Third Embodiment

A third embodiment differs from the first embodiment in the processes of steps S30 through S50 in FIG. 6 and the inspection end condition. The other configuration is similar to that of the first embodiment, so the same symbols are used and a detailed description is omitted.

In the third embodiment, when the inspection section 213 ends the inspection of the workpiece WK, it sends a signal to the control section 160 indicating the end of the inspection of the workpiece WK.

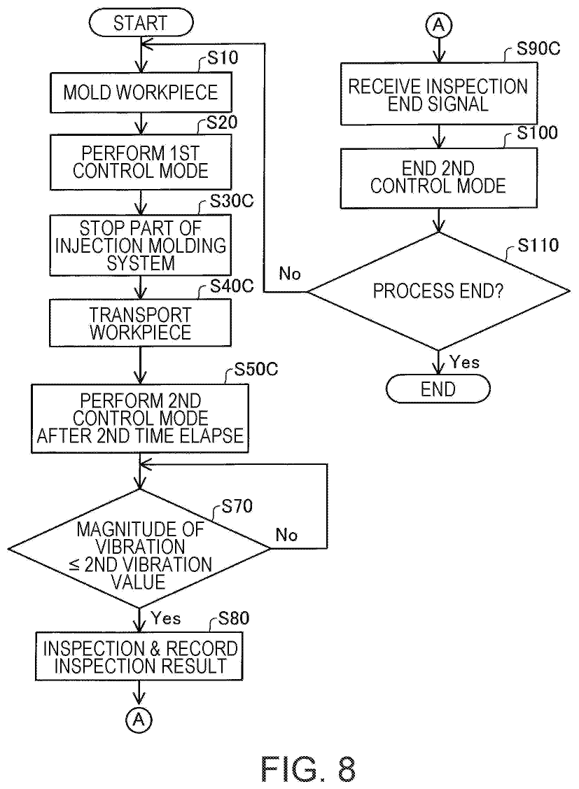

FIG. 8 is a process chart showing an example of the inspection method by the inspection section 213 in the third embodiment. In this third embodiment, in step S30C, some operations of the injection molding system 1 are stopped. In step 40C, the robot 212 holds the workpiece WK. In step S50C, the control section 160 performs the second control mode M2 after the elapse of a second time period, which is a predetermined elapsed time, from when the robot 212 holds the workpiece WK placed in the transport device 140. The control section 160 performs the second control mode M2 before the robot 212 places the workpiece WK in the inspection section 213. In this embodiment, the second time period is 1 second. In step S60 (not shown), the control section 160 causes the robot 212 to perform the stop control to control its operation. Then, the process proceeds to step S90C via steps S70 and S80.

In step S90C, the control section 160 receives the signal indicating the end of inspection of the workpiece WK from the inspection section 213. Then, the process proceeds to step S100.

In the third embodiment, the same effects as in the first embodiment occur. In other words, by operating the robot 212 in the second control mode M2, the vibration of inspection section 213 caused by the vibration generated by the operation of the robot 212 can be suppressed, compared to the control in which the robot 212 is operated in the first control mode M1. By this, the workpiece WK can be inspected stably when the workpiece WK is inspected.

In the third embodiment, the control section 160 performs the second control mode M2 after the second time period, which is a predetermined elapsed time, has elapsed from the time when the operation of the injection molding section 10 is stopped by the control section 160 and the robot 212 holds the workpiece WK placed in the transport device 140. By this, the second control mode M2 is performed with a higher likelihood that the vibration of the inspection section 213 is small compared to the control in which the control section 160 performs the second control mode M2 before the second time period elapses.

Further, after receiving the signal from the inspection section 213 indicating the end of inspection of the workpiece WK, the control mode of the robot 212 is switched from the second control mode M2 to the first control mode M1. Therefore, the inspection by the inspection section 213 surely ends while the second control mode M2 is being performed.

### D. Fourth Embodiment

A fourth embodiment differs from the above embodiments in the second control mode M2 and in the timing at which the inspection of the workpiece WK by the inspection section 213 is performed by the control section 160. The other configuration is similar to that of the above embodiments, so the same symbols are used and a detailed description is omitted.

In the fourth embodiment, the first control mode M1 and the second control mode M2 are performed at predetermined timing by the control section 160. Specifically, the timing of the first control mode M1 and the second control mode M2 is input by the user to the control section 160 in advance so that the reduction in efficiency of molding the workpiece WK due to the operation of the second control mode M2 is minimized. Then, at the predetermined timing, the injection molding system 1 is controlled by the control section 160.

In the fourth embodiment, first, after a signal indicating that the workpiece WK was molded by the injection molding section 10 is sent from the injection molding section 10 to the control section 160, when the workpiece WK is placed in the transport device 140, the control section 160 operates the robot 212 in the first control mode M1 to hold the workpiece WK placed in the transport device 140. The robot 212 then places the workpiece WK in the inspection section 213 while the first control mode M1 is being performed by the control section 160.

After receiving a signal from the robot 212 indicating that the robot 212 placed the workpiece WK in the inspection section 213, the control section 160 causes the robot 212 to operate in the second control mode M2. Note that in the second control mode M2, any one of the vibration reduction control, acceleration and deceleration forbidding control, and stop control may be performed. During the performance of the second control mode M2 by the control section 160, the inspection section 213 starts the inspection of the workpiece WK. Then, the inspection section 213 ends the inspection of the workpiece WK during execution of the second control mode M2 by the control section 160. The start and end of inspection is performed at predetermined timings by the control section 160 during execution of the second control mode M2 by the control section 160. In the fourth embodiment, the time period from the start to the end of the second control mode M2 is 1 second. The time period from the start to the end of the second control mode M2 may be less than one second, or may be one second or more.

In the fourth embodiment, the second control mode M2 is performed at the predetermined timing. Therefore, the possibility of work delays in the injection molding system 1 can be reduced.

### E. Fifth Embodiment

A fifth embodiment differs from the above embodiments in the timing at which the second control mode M2 is performed by the control section 160. The other configuration is similar to that of the above embodiments, so the same symbols are used and a detailed description is omitted.

In this fifth embodiment, the control section 160 switches the control mode of the robot 212 from the first control mode M1 to the second control mode M2 triggered by reception of a signal that notifies the start of the inspection. Specifically, the control section 160 receives the signal that notifies the start of the inspection from a device comprising the injection molding system 1. Then, triggered by this signal, the control mode of the robot 212 is switched from the first control mode M1 to the second control mode M2. The device comprising the injection molding system 1 may be the inspection section 213, the robot 212, or the injection molding section 10.

The signal that notifies the start of an inspection by the device comprising the injection molding system 1 is sent during an operation in which the second control mode M2 has little impact when the second control mode M2 is executed, when comparing a specific operation performed by the device with other operations. For example, in the case the device is the inspection section 213, the signal that notifies the start of the inspection is sent just before the inspection of the workpiece WK is to begin. Specifically, when the camera 213a detects that the workpiece WK is placed by the robot 212, it sends the signal that notifies the start of the inspection. In the case the device is the robot 212, immediately after the workpiece WK is placed in the inspection section 213, the signal that notifies the start of the inspection is sent to the control section 160. In the case the device is the injection molding section 10, the signal that notifies the start of inspection is sent to the control section 160 in between the molding of multiple workpieces WK by injection molding. Note that the timing for sending the signal that notifies the start of the inspection described here is just one example.

After the control section 160 switches the control mode of the robot 212 to the second control mode M2, the inspection section 213 performs inspection of the workpiece WK. The control section 160 switches the control mode of the robot 212 from the second control mode M2 to the first control mode M1 when the control section 160 receives the signal indicating the end of the inspection. The signal indicating the end of the inspection is sent from the inspection section 213.

In the fifth embodiment, the control section 160 performs the second control mode M2 triggered by the signal that notifies the start of the inspection of the workpiece WK. Therefore, it is possible to reduce the decrease in productivity of the injection molding system 1.

### F. Sixth Embodiment

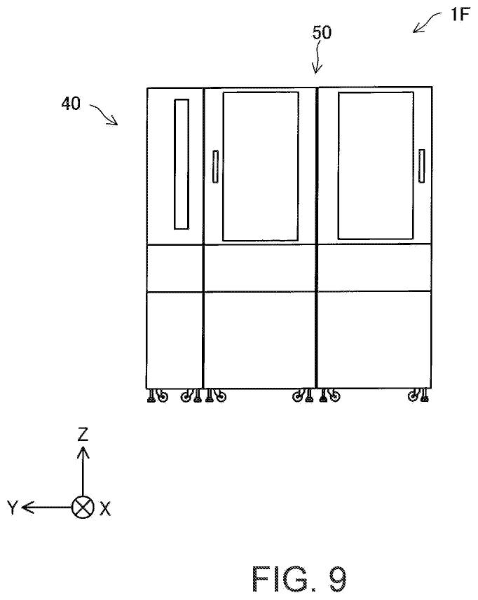

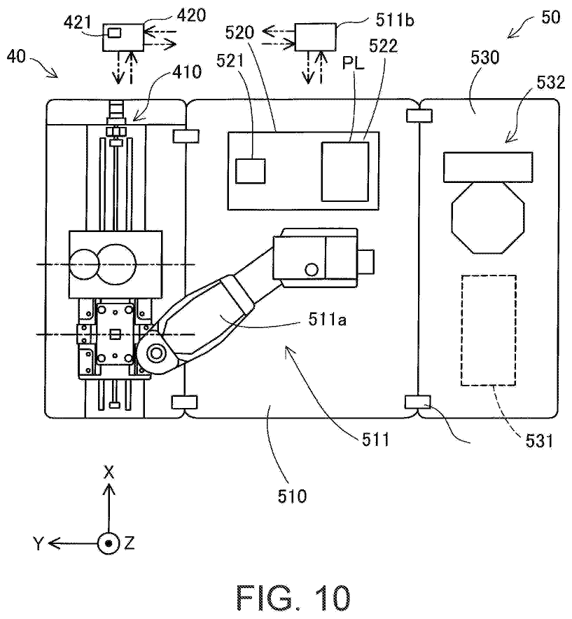

FIG. 9 is a front view showing a schematic configuration of an injection molding system 1F according to the sixth embodiment. FIG. 10 is a plan view showing a schematic configuration of the injection molding system 1F according to the sixth embodiment. The sixth embodiment differs from the above embodiments in the configurations of the injection molding machine, the robot, and the inspection section. The control of the robot by the control section is the same as in the above embodiments, so the details are omitted.

FIGS. 9 and 10 show the X, Y, and Z directions, which are orthogonal to each other. The X-axis and the Y-axis are axes along a horizontal plane, and the Z-axis is an axis along a vertical line. A+Z direction is an upward direction in the vertical direction, and a-Z direction is a downward direction in the vertical direction.

As shown in FIGS. 9 and 10, the injection molding system 1F has a main unit 40 and a second optional unit 50. The main unit 40 and the second optional unit 50, similar to the above embodiment, have a base section, an upper frame, and their peripheries are covered by a cover. As shown in FIG. 2, the main unit 40 has a second injection molding machine 410 and an injection machine control section 420.

The second injection molding machine 410 is configured as an injection molding machine that performs insert molding. The injection machine control section 420 is composed of a computer with a processor, a storage section 421, and an input and output interface that inputs and outputs signals to and from the outside. A program is loaded into storage section 421 and the processor executes the program to control the second injection molding machine 410. The processor also performs the function of the overall control of the injection molding system 1F by controlling a robot unit 510, an inspection unit 520, and an ancillary equipment unit 530, all of which are provided in the second optional unit 50, as described below. In the sixth embodiment, the second injection molding machine has an injection unit, which causes material to flow, and a mold die clamping mechanism (not shown), which opens and closes the molding die, aligned in the vertical direction.

The second optional unit 50 has a robot unit 510, an inspection unit 520, and an ancillary equipment unit 530. The robot unit 510 has a second robot 511. The second robot 511 transports the workpiece molded by the second injection molding machine 410 to the inspection section 521. The second robot 511 is configured by a horizontal articulated robot. The second robot 511 may not be the horizontal articulated robot, and may be, for example, a Cartesian coordinate robot or a vertically articulated robot. The second robot 511 has an arm 511a and a robot control section 511b.

The arm 511a has an end-effector. A suction pad is attached to the arm 511a as the end-effector that sucks the workpiece. The workpiece molded by the second injection molding machine 410 is sucked by the suction pads, and the workpiece is transported to the inspection section 521. The second robot 511 is mounted on a base section with a plate-shaped base that is fixed to a housing of the robot unit 510.

The robot control section 511b, similar to the injection machine control section 420, is composed of a computer. The robot control section 511b controls operations of the arm 511a and end-effector, and causes the robot 212 to perform various functions by executing programs and instructions loaded in the storage device by the processor. In the sixth embodiment, the operation of the second robot is controlled by the processor of the injection machine control section 420 via the robot control section 511b.

The inspection unit 520 has an inspection section 521 and a third placement section 522. In FIG. 10, the inspection section 521 is located on a base section with a plate-shaped base that is fixed to the housing of the robot unit 510. Note that the inspection unit 520 may be separate from the robot unit 510. For example, the inspection unit 520 may be attached to the main unit 40.

The inspection section 521 inspects the workpiece transported by the second robot 511. Specifically, as in the above embodiments, the inspection section 521 determines the difference between a shape of the workpiece and a shape of a reference workpiece based on the image captured by the camera which is provided in the inspection section 521. The inspection section 521 sends a signal indicating the inspection result to the injection machine control section 420. By this, the inspection result is stored in the storage section by the injection machine control section 420.

The ancillary equipment unit 530 has a mold temperature control machine 531 and a material feeding device 532. The mold temperature control machine 531 circulates hot medium through pipes (not shown) to the cooling pipes of the molding die, which are located in the second injection molding machine 410 to regulate the temperature of the molding die. The material feeding device 532 is composed of a dryer that stores the material used in the second injection molding machine 410 while dehumidifying and drying it, and a loader that feeds the material stored in the dryer to the material supply section via a tube or the like (not shown).

In the sixth embodiment, similar to the above embodiment, the control section 160 is used to control the operation of the robot 212. By this, it is possible to suppress the inspection section 213 from vibrating due to the vibration generated by the operation of the robot 212. By this, the workpiece WK can be inspected stably when the workpiece WK is inspected.

### G. Other Embodiments

### G1. Other Embodiment 1

(1) In the above embodiments, the inspection section 213 has the vibration measurement section 213c. Note that the inspection section may not have the vibration measurement section if, for example, the control section is a control that performs the first control mode and the second control mode at predetermined timing. The vibration measurement section 213c is located on the inspection table 213b. Note that the vibration measurement section 213c may be located on the camera 213a. The vibration measurement section 213c may be located in the second housing 211, the robot 212, or the stacking mechanism 214.

(2) In the first to third embodiments above, the control section 160 stops some of the operations of the injection molding section 10 before the control section performs the second control mode M2. Note that the control section may slow down the motion of some of the injection molding section before the performance of the second control mode. For example, the control section may stop the operation of the stacking mechanism before the performance of the second control mode. For example, the operation of the injection molding section may be stopped before step S20 in FIG. 6. Stopping the operation of the injection molding section can be changed by the user according to how easily the inspection section tends to vibrate in the environment in which the injection molding system is located, the shape of the workpiece, and the like. The control section need not to stop the operation of the injection molding section in a control in which the first control mode, the second control mode, and the inspection of the workpiece by the inspection section are performed at predetermined timings or in a control in which the control mode of the robot is switched from the first control mode to the second control mode triggered by the reception of the signal that notifies the start of inspection.

(3) In the first embodiment above, the control section 160 causes the robot 212 to perform the second control mode M2 when a predetermined second control mode start condition is satisfied, causes the inspection section 213 to start inspection after a predetermined inspection start condition is satisfied, and ends the second control mode M2 based on a predetermined inspection end condition of the workpiece WK. Note that, for example, in a control in which the control section performs the first control mode and the second control mode at the predetermined timing, the control section may not cause the robot to perform the second control mode when the predetermined second control mode start condition is satisfied, may not cause the inspection section to start inspection after the predetermined inspection start condition is satisfied, and may not end the second control mode based on the predetermined inspection end condition of the workpiece.

The control section may perform the second control mode when the predetermined second control mode start condition is satisfied, may cause the inspection section to perform inspection at the same time as the second control mode is performed, and may end the second control mode based on the predetermined workpiece inspection end condition. For example, the control section may cause the robot to perform the second control mode from the time when the robot places the workpiece in the inspection section, may cause the inspection section to start the inspection after the predetermined inspection start condition is satisfied, and may end the second control mode based on the predetermined inspection end condition of the workpiece.

(4) In the first embodiment and the second embodiment above, the control section 160 performs the second control mode M2 after the workpiece WK is transported from the transport device 140 to the inspection section 213 by the robot 212 and the second control mode start condition is satisfied. In the third embodiment above, the control section 160 performs the second control mode M2 after the robot 212 holds the workpiece WK placed on the transport device 140 and after the second control mode start condition is satisfied. Note that the control section may perform the second control mode if, for example, the second control mode start condition is satisfied when the robot is moving toward the transport device in order to hold the workpiece.

(5) If the robot holds the workpiece while the second control mode is being performed, another workpiece already placed in the inspection section may be inspected. For example, in a configuration where multiple workpieces can be placed in the inspection section, if the robot holds the workpiece placed in the transport device, the control section performs the stop control, and the robot stops. Then, another workpiece placed in the inspection section may be inspected.

(6) As described in the first to fifth embodiments above, the control section can perform the second control mode even when the workpiece is not being inspected by the inspection section. Note that the inspection by the inspection section may be performed at the same time as the second control mode is performed and may end at the same time as the end of the second control mode. It is sufficient that the second control mode be performed by the control section at least when the workpiece is being inspected by the inspection section.

(7) In this embodiment, if the control signal generation section 162a receives an instruction to perform tracking control from the user, the control signal generation section 162a outputs a control signal to perform tracking control to the position control section 162b. Note that, for example, in a configuration where the robot has a force sensor, the control signal generation section may receive an instruction to perform force control from the user and may output a control signal to perform force control to the position control section. In this case, the control signal generation section generates a force control signal that represents the force to be generated by the holding section and a direction of that force, as well as the torque and the direction of that torque, and outputs it to the force control section.

(8) In the second embodiment and the third embodiment, the first time period is 5 seconds, the second time period is 1 second, the third time period is 1 second, and the fourth time period is 1 second. Note that the first to fourth time period are not limited to the times in the above embodiment, for example, the first time period may be 1 second or 10 seconds, the second time period may be 0.1 second, and so on.

(9) In the embodiments above, each of the first housing 110, the second housing 211, and the third housing 221 of the injection molding system 1 has a cover (not shown). The cover may be divided into a lower cover, which is attached to the base section, and an upper cover, which is attached to the upper frame. The injection molding system may also be configured so that the first, second, and third housings are not provided with covers. In the above embodiments, each of the first housing 110, the second housing 211, and the third housing 221 of the injection molding system 1 is configured to have the base frame and the upper frame via the base. The upper frame may be directly connected to the base frame without a base, and the base frame and upper frame may be integrated into a single unit. The upper frame may be a cube-shaped frame with each vertex connected by connection members. The base frame may not be a cube-shaped frame but may be a simple structure that connects upper and lower bases with pillars.

### G2. Other Embodiment 2

In the above embodiments, the control section 160 performs one of the vibration reduction control, the acceleration and deceleration forbidding control, and the stop control. Note that, for example, in a control in which the control section does not perform the acceleration and deceleration forbidding control and the stop control, the second control mode may be a control mode in which the robot is operated using an operation signal in which a frequency component corresponding to the natural frequency including the inspection section is reduced with respect to the original operation signal to drive the robot.

### G3. Other Embodiment 3

In the above embodiments, the control section 160 performs one of the vibration reduction control, the acceleration and deceleration forbidding control, and the stop control. Note that, for example, in a control in which the control section does not perform the vibration reduction control and the stop control, the second control mode may be a control mode in which acceleration and deceleration of the robot are forbidden.

### G4. Other Embodiment 4

In the above embodiments, the control section 160 performs one of the vibration reduction control, the acceleration and deceleration forbidding control, and the stop control. Note that, for example, in a control in which the control section does not perform the vibration reduction control and the acceleration and deceleration forbidding control, the second control mode may be a control mode that stops the operation of the robot. In this control, the generation of vibration by the robot can be suppressed. Therefore, the inspection section can perform a highly accurate inspection.

### G5. Other Embodiment 5

(1) In the above embodiments, the control section 160 performs one of the vibration reduction control, the acceleration and deceleration forbidding control, and the stop control. Note that, for example, of the vibration reduction control, acceleration and deceleration forbidding control, and stop control, the control section may perform two controls, the vibration reduction control and the stop control.

(2) In the above embodiments, the control section 160 performs one of the vibration reduction control, the control that forbids acceleration and deceleration, and the stop control, based on the workpiece vibration information, which indicates how easily the workpiece tends to vibrate and which was obtained in advance, and the inspection section vibration information, which indicates how easily the inspection section 213 tends to vibrate and which was obtained in advance. Note that, for example, the control section may perform one of the vibration reduction control, the control that forbids acceleration and deceleration, and the stop control based on only the inspection section vibration information, which indicates how easily the inspection section tends to vibrate and which was obtained in advance. For example, the control section may be instructed, by a user, which of the vibration reduction control, the control that forbids to accelerate and decelerate, or the stop control is to be selected in advance.

### G6. Other Embodiment 6

In the above embodiments, the robot 212 and the inspection section 213 are mounted on the same mounting section. Note that, for example, in a configuration where the inspection section is located within the movable range of the robot, the robot and the inspection section may be mounted on different mounting sections.

### G7. Other Embodiment 7

In the fourth embodiment above, the timing of the first control mode M1 and the second control mode M2 is input in advance by the user to the control section 160 so that the reduction in efficiency of molding the workpiece WK due to the performance of the second control mode M2 is minimized. Note that the predetermined timing may be the timing determined by the user, for example, so that the processes from molding to the inspection of the workpiece can be completed within the user's desired time frame.

In the first to fifth embodiments, the timing of the performance of the second control mode by the control section, and the timing of the start and end of the inspection of the workpiece by the inspection section may all be at the same time.

### G8. Other Embodiment 8

In the fifth embodiment above, the signal that notifies the start of an inspection by the device comprising the injection molding system 1 is sent during an operation in which the second control mode M2 has a smaller impact when the second control mode M2 is performed, when comparing one specific operation performed by the device with other operations. However, the signal that notifies the start of the inspection may be sent at another timing.

### G9. Other Embodiment 9

The control section 160 causes the inspection section 213 to start the inspection after a predetermined inspection start condition is satisfied. Note that, for example, in a control in which the first control mode and the second control mode are performed at predetermined timings, the control section may cause the inspection section to start the inspection before the predetermined inspection start condition is satisfied.

In a control in which the first control mode and the second control mode are performed at predetermined timings, the control section may end the inspection before a predetermined inspection end condition is satisfied.

### H. Other Aspects

The present disclosure is not limited to the embodiments described above, and can be realized in various aspects without departing from the scope of the present disclosure. For example, the present disclosure can also be realized by the following aspects. The technical features in the above-described embodiments corresponding to the technical features in each aspect described below can be appropriately replaced or combined in order to solve a part or all of the problems of the present disclosure or to achieve a part or all of the effects of the present disclosure. Unless the technical features are described as essential in the present specification, the technical features can be appropriately deleted. (1) According to one aspect of the present disclosure, an injection molding system is provided. This injection molding system includes an injection molding section that molds a workpiece by injection molding; a robot that transports the workpiece; an inspection section that inspects the workpiece transported by the robot; and a control section that controls the injection molding section, the robot, and the inspection section; wherein the control section has, as control modes of the robot, a first control mode that is performed when the workpiece is not being inspected by the inspection section and a second control mode that is performed when the workpiece is being inspected by the inspection section, and that causes the robot to operate so that vibration of the inspection section is suppressed more than in the first control mode.

According to this aspect of the injection molding system, since the robot is operated in the second control mode, the vibration of the inspection section due to the vibration caused by the operation of the robot can be suppressed compared to the control where the robot is operated in the first control mode. By this, the workpiece can be inspected in a stable condition when the workpiece is being inspected.

(2) In the injection molding system of the above aspect, the second control mode may be a control mode in which the robot is operated using an operation signal in which the frequency component corresponding to the natural frequency of the inspection section is reduced with respect to the original operation signal to drive the robot. According to this aspect of the injection molding system, the inspection section can perform highly accurate inspection while maintaining productivity.

(3) In the injection molding system of the above aspect, the second control mode may be a control mode that forbids the robot from accelerating and decelerating. According to this aspect of the injection molding system, acceleration and deceleration of the robot are forbidden. Therefore, vibrations caused by the operation of the robot can be suppressed. Therefore, the accuracy of the inspection is improved.

(4) In the injection molding system of the above aspect, the second control mode may be a control mode that stops the operation of the robot. According to this aspect of the injection molding system, the vibration caused by the robot can be suppressed. Therefore, highly accurate inspection can be performed.

(5) In the injection molding system of the above aspect, the second control mode may be a control mode that performs one of a vibration reduction control that causes the robot to operate using an operation signal whose frequency component corresponding to a natural frequency including the inspection section is reduced with respect to an original operation signal that drives the robot, a control that forbids the robot to accelerate and decelerate, and a stop control that is a control to stop an operation of the robot and the control section may perform, based on workpiece vibration information, which indicates how easily the workpiece tends to vibrate and which was obtained in advance, and inspection section vibration information, which indicates how easily the inspection section tends to vibrate and which was obtained in advance, one of the vibration reduction control, the control forbidding acceleration and deceleration, and the stop control. According to this aspect of the injection molding system, the control mode can be selected based on the workpiece vibration information and the inspection section vibration information.

(6) In the injection molding system of the above aspect, the robot and the inspection section may be mounted on the same mounting section. According to this aspect of the injection molding system, even if the robot and the inspection section are mounted on the same mounting section, the vibration of the inspection section can be suppressed compared to a control in which the control section does not perform the second control mode.

(7) In the injection molding system of the above aspect, the control section may perform the first control mode and the second control mode at a predetermined timing, and the inspection may start and end during the performance of the second control mode. According to this aspect of the injection molding system, since the second control mode is performed at the predetermined timing, it is possible to reduce the possibility of work delay in the injection molding system.

(8) In the injection molding system of the above aspect, the control section may switch the control mode of the robot from the first control mode to the second control mode triggered by a reception of a signal that notifies the start of the inspection, and may switch the control mode of the robot from the second control mode to the first control mode triggered by a reception of a signal indicating the end of the inspection. According to this aspect of the injection molding system, since the control section performs the second control mode triggered by the reception of the signal that notifies the start of the inspection of the workpiece, it is possible to reduce the possibility of decrease in the productivity of the injection molding system.

(9) In the injection molding system of the above aspect, the control section may cause the inspection section to start inspection after a predetermined inspection start condition is satisfied. Wherein the predetermined inspection start condition may be one of (a1) a predetermined time has elapsed after the start of the second control mode, and (a2) a magnitude of vibration of the inspection section, which is obtained by the vibration measurement section provided in the inspection section after the start of the second control mode, is less than or equal to a predetermined magnitude. According to this aspect of the injection molding system, in the case of (a1), the user can control the timing of the start of the inspection. In the case of (a2), the inspection can be performed with higher accuracy compared to a control in which the inspection is performed with vibration greater than the predetermined magnitude.

(10) According to another aspect in this disclosure, a control method of an injection molding system is provided. The control method of an injection molding system includes molding a workpiece by an injection molding section, transporting the workpiece by a robot, and by a control section, which controls the injection molding section, the robot, and an inspection section that inspects the workpiece transported by the robot, performing a first control mode as a control mode of the robot, when the workpiece is not being inspected by the inspection section; and performing a second control mode that causes the robot to operate to suppress the vibration of the inspection section more than is in the first control mode, as the control mode of the robot, when the workpiece is being inspected by the inspection section.

1. An injection molding system comprising:
an injection molding section that molds a workpiece by injection molding;
a robot that transports the workpiece;
an inspection section that inspects the workpiece transported by the robot; and
a control section that controls the injection molding section, the robot, and the inspection section; wherein
the control section has, as control modes of the robot,
a first control mode that is performed when the workpiece is not being inspected by the inspection section and
a second control mode that is performed when the workpiece is being inspected by the inspection section, and that causes the robot to operate so that vibration of the inspection section is suppressed more than in the first control mode.

2. The injection molding system according to claim 1, wherein
the second control mode is a control mode that causes the robot to operate using an operation signal in which a frequency component corresponding to a natural frequency of the inspection section is reduced with respect to an original operation signal that drives the robot.

3. The injection molding system according to claim 1, wherein
the second control mode is a control mode that forbids the robot to accelerate and decelerate.

4. The injection molding system according to claim 1, wherein
the second control mode is a control mode that stops an operation of the robot.

5. The injection molding system according to claim 1, wherein
the second control mode is a control mode that performs one of
a vibration reduction control that causes the robot to operate using an operation signal whose frequency component corresponding to a natural frequency including the inspection section is reduced with respect to an original operation signal that drives the robot,
a control that forbids the robot to accelerate and decelerate, and
a stop control that is a control to stop an operation of the robot and
the control section performs, based on workpiece vibration information, which indicates how easily the workpiece tends to vibrate and which was obtained in advance, and inspection section vibration information, which indicates how easily the inspection section tends to vibrate and which was obtained in advance, one of the vibration reduction control, the control that forbids to accelerate and decelerate, and the stop control.

6. The injection molding system according to claim 1, wherein
the robot and the inspection section are mounted on a same mounting section.

7. The injection molding system according to claim 1, wherein
the control section performs the first control mode and the second control mode at predetermined timings and
the inspection section performs start and end of the inspection during performance of the second control mode.

8. The injection molding system according to claim 1, wherein
the control section
switches the control mode of the robot from the first control mode to the second control mode as triggered by reception of a signal that notifies start of the inspection and
switches the control mode of the robot from the second control mode to the first control mode as triggered by reception of a signal that indicates end of the inspection.

9. The injection molding system according to claim 1, wherein
the control section causes the inspection section to start inspection after either of the following is satisfied:
(a1) a predetermined time elapses after the start of the second control mode or
(a2) a magnitude of vibration of the inspection section, which is obtained by a vibration measurement section provided in the inspection section, is less than or equal to a predetermined magnitude after the start of the second control mode.

10. A control method for an injection molding system including an injection molding section that molds a workpiece, a robot that transports the workpiece, an inspection section that inspects the workpiece transported by the robot, and a control section that controls the injection molding section, the robot, and the inspection section,
the control method for the injection molding system comprising:
molding the workpiece by the injection molding section;
transporting the workpiece by the robot;
when the workpiece is not being inspected by the inspection section, performing by the control section a first control mode as a control mode of the robot; and
when the workpiece is being inspected by the inspection section, performing by the control section a second control mode that causes the robot to operate to suppress vibration of the inspection section more than in the first control mode as the control mode of the robot.
